(19) United States
(12) Patent Application Publication
(10) Pub. No.: US 2024/0420458 A1
(43) Pub. Date: Dec. 19, 2024

(54) CROSS-MODAL DATA PROCESSING METHOD AND APPARATUS, DEVICE, MEDIUM, AND PROGRAM PRODUCT

(71) Applicants: Lemon Inc., Grand Cayman (KY); BEIJING ZITIAO NETWORK TECHNOLOGY CO., LTD., Haidian District (CN); INSTITUTE OF AUTOMATION CHINESE ACADEMY OF SCIENCES, Beijing (CN)

(72) Inventors: Xiaojie JIN, Los Angeles, CA (US); Sihan CHEN, Beijing (CN); Jiashi FENG, Singapore (SG); Xingjian HE, Beijing (CN); Handong LI, Beijing (CN); Jing LIU, Beijing (CN)

(21) Appl. No.: 18/744,418

(22) Filed: Jun. 14, 2024

(30) Foreign Application Priority Data
Jun. 15, 2023 (CN) 202310716454.8

(51) Int. Cl. G06V 10/80; G06V 10/44; G06V 10/74

(52) U.S. Cl. CPC G06V 10/806; G06V 10/44; G06V 10/761

(57) ABSTRACT

The disclosure provides a cross-modal data processing method and apparatus, a device, a storage medium, and a program product. The method comprises: obtaining first modal data to be processed; obtaining a first modal data feature by performing feature extraction based on the first modal data; and obtaining second modal data based on the first modal data feature and a cross-modal processing model, the first modal data and the second modal data having different modalities, wherein the cross-modal processing model needs to be pre-trained based on a concatenated training sample, and the concatenated training sample comprises a concatenated image sample and a corresponding concatenated text sample.

### CROSS-REFERENCE TO RELATED APPLICATION(S)

This application claims priority to Chinese Application No. 202310716454.8 filed on Jun. 15, 2023, the disclosure of which is incorporated herein by reference in its entirety.

### FIELD

The disclosure relates to the field of computer technology, and in particular to a cross-modal data processing method and apparatus, a device, a medium, and a program product.

### BACKGROUND

An existing visual-text model has some limitations in dealing with temporal semantic representations and correlations between images and videos. The visual-text model often fails to learn temporal understanding capabilities in a pre-training stage.

### SUMMARY

In a first aspect, the disclosure provides a cross-modal data processing method, comprising:
obtaining first modal data to be processed;
obtaining a first modal data feature by performing feature extraction based on the first modal data; and
obtaining second modal data based on the first modal data feature and a cross-modal processing model, the first modal data and the second modal data having different modalities,
wherein the cross-modal processing model needs to be pre-trained based on a concatenated training sample, and the concatenated training sample comprises a concatenated image sample and a corresponding concatenated text sample.

In a second aspect, the disclosure provides a cross-modal data processing apparatus, comprising:
an obtaining module, configured to obtain first modal data to be processed; and
a model module, configured to obtain a first modal data feature by performing feature extraction based on the first modal data, and obtain second modal data based on the first modal data feature and a cross-modal processing model, the first modal data and the second modal data having different modalities,
wherein the cross-modal processing model needs to be pre-trained based on a concatenated training sample, and the concatenated training sample comprises a concatenated image sample and a corresponding concatenated text sample.

In a third aspect, the disclosure provides an electronic device, comprising one or more processors, a memory, and one or more programs, where the one or more programs are stored in the memory, and executed by the one or more processors, and the program comprises instructions to perform the method in the first aspect.

In a fourth aspect, the disclosure provides a non-volatile computer-readable storage medium comprising a computer program. The computer program, when executed by one or more processors, causes the processor to perform the method in the first aspect.

In a fifth aspect, the disclosure provides a computer program product, comprising computer program instructions. The computer program instructions, when executed on a computer, cause the computer to perform the method in the first aspect.

### BRIEF DESCRIPTION OF THE DRAWINGS

In order to describe the technical solutions of the disclosure or the related art more clearly, the accompanying drawings required for describing the embodiments or the related art will be briefly introduced below. Apparently, the accompanying drawings in the following description are merely embodiments of the disclosure, and those of ordinary skill in the art may also obtain other accompanying drawings according to these accompanying drawings without creative efforts.

FIG. 1 is a schematic diagram of a cross-modal data processing architecture according to an embodiment of the disclosure.

FIG. 2 is a schematic diagram of a hardware structure of an exemplary electronic device according to an embodiment of the disclosure.

FIG. 3 is a schematic diagram of a model architecture of a cross-modal data processing model according to an embodiment of the disclosure.

FIG. 4 is a schematic diagram of a training sample according to an embodiment of the disclosure.

FIG. 5 is a schematic flowchart of a cross-modal data processing method according to an embodiment of the disclosure.

FIG. 6 is a schematic diagram of a cross-modal data processing apparatus according to an embodiment of the disclosure.

### DETAILED DESCRIPTION OF EMBODIMENTS

To have a more clear understanding of objectives, technical solutions, and advantages of the disclosure, the disclosure is further described in detail in conjunction with specific embodiments and with reference to the accompanying drawings below.

It should be noted that unless otherwise defined, the technical or scientific terms used in the embodiments of the disclosure should have ordinary meanings understood by those of ordinary skill in the art of the disclosure. “First”, “second”, and similar words used in the embodiments of the disclosure are merely used for distinguishing different components instead of representing any sequence, quantity, or importance. Similar words such as “comprise” or “comprise” are intended to indicate that elements or objects appearing in front of the word cover elements or objects listed behind the word, as well as equivalents without excluding other elements or objects. Similar words such as “connected” or “linked” are not limited to physical or mechanical connections, but may comprise electrical connections, regardless of direct connections or indirect connections. “Upper”, “lower””, “left”, “right”, etc. are merely used for representing a relative positional relationship, and after the absolute position of a described object changes, the relative positional relationship may correspondingly change.

As described above, an existing visual-text model has some limitations in dealing with temporal semantic representations and correlations between images and videos. The visual-text model often fails to learn temporal understanding capabilities in a pre-training stage. Even if subsequent fine-tuning training is performed, the limited amount of data will result in average final performance of the model. Even if pre-training is performed in conjunction with using image-text and video-text data, the number of samples in an image-text corpus is much larger than that in a video-text corpus, as a result, video-text samples are easily ignored, and additionally, the problems such as high visual redundancy of the video-text corpus and monotonous scenes and descriptions exist, causing that a visual-text-based cross-modal data processing model is not high in accuracy, and task processing performance cannot be improved.

The disclosure provides a cross-modal data processing method and apparatus, a device, a storage medium, and a program product so as to solve the technical problem of low accuracy of cross-modal data processing to a certain degree. According to some embodiments of the present disclosure, in a pre-training stage, by training the cross-modal processing model using the concatenated image sample and the concatenated text sample and converting an image and text sample pair into a concatenated image-concatenated text sample pair, a temporal sequence correspondence is kept, and rich scene transition and descriptive information are provided, such that the cross-modal processing model can learn explicit scene-level time alignment, and the capability of learning static and temporal information is improved, thereby the accuracy and efficiency of a cross-modal data processing task is improved.

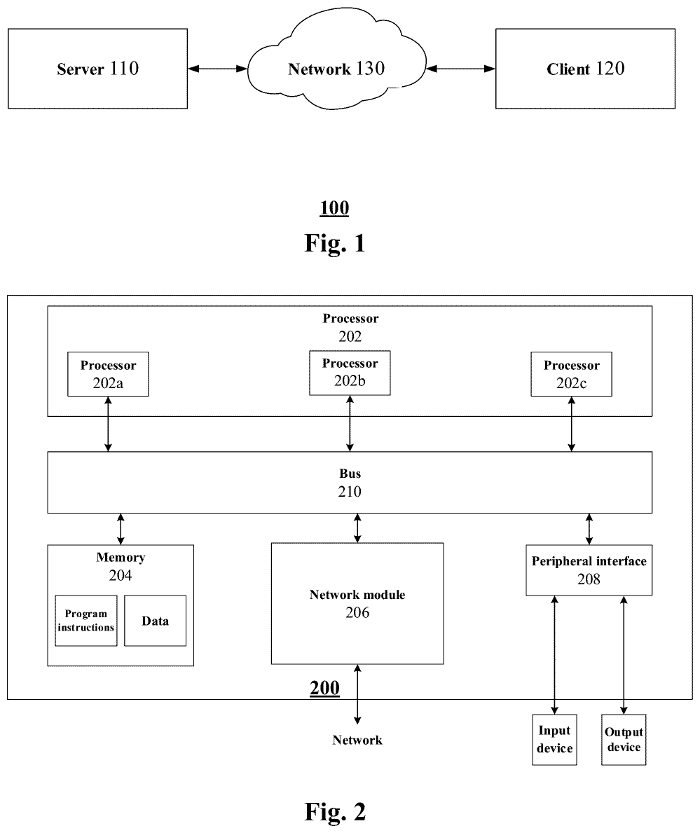

FIG. 1 illustrates a schematic diagram of a cross-modal data processing architecture according to an embodiment of the disclosure. Referring to FIG. 1, the cross-modal data processing architecture 100 may comprise a server 110, a terminal 120, and a network 130 providing a communication link. The server 110 and the terminal 120 may be connected through a wired or wireless network 130. The server 110 may be an independent physical server, or a server cluster or a distributed system composed of a plurality of physical servers, or may be a cloud server providing basic cloud computing services such as a cloud service, a cloud database, cloud computing, a cloud function, cloud storage, a network service, cloud communication, a middleware service, a security service, and a content delivery network (CDN).

The terminal 120 may be implemented through hardware or software. For example, when the terminal 120 is implemented through hardware, the terminal 120 may be various electronic devices having display screens and supporting page displaying, comprising but not limited to a smart phone, a tablet, an e-book reader, a laptop, a desk computer, etc. When the terminal 120 is implemented through software, the terminal 120 may be installed on the electronic device listed above, and may be implemented as a plurality of software or software modules (e.g., software or software modules configured to provide distributed services), or as a single software or software module. No specific limitations are imposed here.

It should be noted that a cross-modal data processing method provided in this embodiment of this application may be performed by the terminal 120 or the server 110. It should be understood that the number of terminals, networks, and servers in FIG. 1 is for an illustrative purpose only, and is not intended to impose limitations. According to implementation needs, there may be any number of terminals, networks, and servers.

FIG. 2 illustrates a schematic diagram of a hardware structure of an exemplary electronic device 200 according to an embodiment of the disclosure. As shown in FIG. 2, the electronic device 200 may comprise: a processor 202, a memory 204, a network module 206, a peripheral interface 208, and a bus 210. The processor 202, the memory 204, the network module 206, and the peripheral interface 208 are mutually in communication connection in the electronic device 200 through the bus 210.

The processor 202 may be a central processing unit (CPU), an image processor, a neural processing unit (NPU), a microcontroller unit (MCU), a programmable logic device, a digital signal processor (DSP), an application specific integrated circuit (ASIC), or one or more integrated circuits. The processor 202 may be configured to perform functions related to the technology described in the disclosure. In some embodiments, the processor 202 may further comprise a plurality of processors integrated into a single logical component. For example, as shown in FIG. 2, the processor 202 may comprise a plurality of processors 202a, 202b, and 202c.

The memory 204 may be configured to store data (e.g., instructions and computer code). As shown in FIG. 2, the data stored in the memory 204 may comprise program instructions (e.g., program instructions for implementing the cross-modal data processing method in this embodiment of the disclosure) and data to be processed (e.g., the memory may store configuration files for other modules). The processor 202 may also access the program instructions and the data stored in the memory 204 and execute the program instructions to operate the data to be processed. The memory 204 may comprise a volatile storage apparatus or a non-volatile storage apparatus. In some embodiments, the memory 204 may comprise a random access memory (RAM), a read only memory (ROM), an optical disk, a magnetic disk, a hard drive, a solid state drive (SSD), a flash memory, a memory stick, etc.

The network module 206 may be configured to provide communication between the electronic device 200 and other external devices via a network. The network may be any wired or wireless network capable of transmitting and receiving data. For example, the network may be a wired network, a local wireless network (e.g., Bluetooth, WiFi, and near field communication (NFC)), a cellular network, the Internet, or a combination of the above. It should be understood that the type of network is not limited to the above specific examples. In some embodiments, the network module 306 may comprise any combination of any number of network interface controllers (NICs), radio frequency modules, transceivers, modems, routers, gateways, adapters, cellular network chips, etc.

The peripheral interface 208 may be configured to connect the electronic device 200 with one or more peripheral apparatuses to achieve information input and output. For example, the peripheral apparatus may comprise an input device such as a keyboard, a mouse, a touchpad, a touchscreen, a microphone, and various sensors, as well as an output device such as a display, a speaker, a vibrator, and an indicator light.

The bus 210 may be configured to transmit information between various components of the electronic device 200 (e.g., the processor 202, the memory 204, the network module 206, and the peripheral interface 208), such as an internal bus (e.g., a processor-memory bus) and an external bus (a USB port and a PCI-E bus).

It should be noted that although the architecture of the above electronic device 200 only shows the processor 202, the memory 204, the network module 206, the peripheral interface 208, and the bus 210, in the specific implementation process, the architecture of the electronic device 200 may also comprise other components necessary for normal operation. In addition, those skilled in the art should understand that the architecture of the above electronic device 200 may also only comprise components necessary for implementing the solutions of the embodiments of the disclosure, and does not necessarily comprise all the components shown in the figures.

An image-text pre-training model and a video-text pre-training model have powerful cross-modal data processing capabilities between visual and language fields, such as various visual-language tasks comprising cross-modal retrieval, visual description generation, and visual question answering. However, in related technologies, the image-text model and the video-text model are independently trained using different cross-modal corpora, network architectures, and training objectives. Considering that a video may be regarded as a combination of a plurality of frames of image, and an image may be regarded as a static video, a relationship between a text and vision (the image and the video) may be modeled uniformly to train a general cross-modal basic model.

An existing visual-text model has some limitations in dealing with temporal semantic representations and correlations between images and videos. Typically, an image-text basic model pre-trained on a large number of image-text data is finely tuned for a video downstream task. However, the trained model does not obtain the ability to understand video temporal sequences in a pre-training stage. Additionally, due to the limited amount of data in a fine-tuning stage, the final performance of the model may be mediocre. Although pre-training may be performed in conjunction with using image-text and video-text data in the related art, the size of the video-text corpus is two orders of magnitude smaller than that of the image-text corpus. As a result, the video-text corpus is more easily overwhelmed by the image-text corpus. In addition, the existing video-text corpus has the problems of high visual redundancy, monotonous scenes and descriptions, etc., which is not beneficial for the model to learn action-level and event-level temporal sequences. Therefore, how to improve the performance of a cross-modal data processing model in a pre-training stage so as to enhance accuracy and efficiency of a cross-modal data processing task has become an urgent technical problem to be solved.

In view of this, embodiments of the disclosure provide a cross-modal data processing method and apparatus, a device, a medium, and a program product. In a pre-training stage, by training a cross-modal processing model using a concatenated image sample and a concatenated text sample and converting an image and text sample pair into a concatenated image-concatenated text sample pair, a temporal sequence correspondence is kept, and rich scene transition and descriptive information are provided, such that the cross-modal processing model can learn explicit scene-level time alignment, and the capability of learning static and temporal information is improved, thereby the accuracy and efficiency of the cross-modal data processing task is improved.

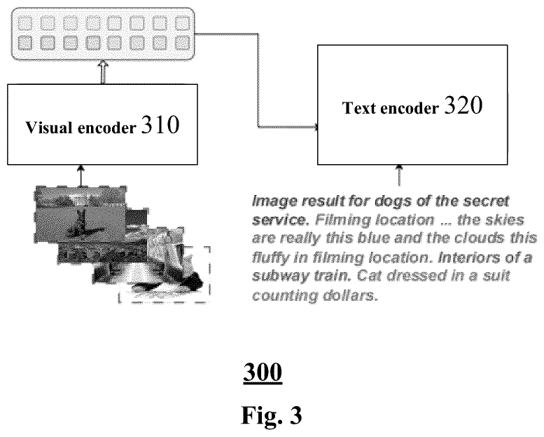

Referring to FIG. 3, FIG. 3 illustrates a schematic diagram of a multi-modal processing model architecture according to an embodiment of the disclosure. In FIG. 3, a cross-modal data processing model 300 may comprise a visual encoder 310 and a text encoder 320. Input of the visual encoder 310 may be image data (e.g., a single image or an image sequence), and output may be a corresponding image feature (or an image feature sequence). In some embodiments, the visual encoder 310 may be a unimodal encoder. Input of the text encoder 320 may be text information, and output may be a text feature corresponding to the text information. In some embodiments, the text encoder 320 may be a bidirectional encoder representations from transformers (BERT). Furthermore, in some embodiments, the text encoder 320 may comprise a self-attention layer, a cross-attention layer, and a feed-forward layer. Specifically, the self-attention layer performs self-attention calculation on an input text of the text encoder 320 to obtain text self-attention feature. The cross-attention layer performs cross-attention calculation on the text self-attention feature and image feature outputted by the visual encoder 310 to obtain a text-image cross-attention feature, namely a multi-modal feature. The feed-forward layer outputs target data based on the multi-modal feature. Accordingly, the text encoder 320 may serve as the unimodal encoder to encode text data, or may serve as a cross-modal encoder to fuse the visual feature and the text feature, or may serve as a decoder to output final target data, thereby achieving cross-modal interaction.

In some embodiments, pre-training, by a multi-modal processing model, an initial model based on a concatenated training sample specifically comprises:
obtaining the concatenated training sample, wherein the training sample comprises the concatenated image sample and the corresponding concatenated text sample;
obtaining a concatenated image feature with time information by performing feature extraction based on the concatenated image sample, and obtaining a concatenated text feature with a temporal sequence relationship by performing feature extraction based on the text sample;
obtaining a multi-modal feature by performing fusing based on the concatenated image feature and the concatenated text feature; and
pre-training the initial model based on the concatenated image sample, the concatenated text sample, and the multi-modal feature.

Images and texts in the concatenated training sample are in one-to-one correspondence, and after the feature extraction, the time information in the concatenated image feature and the temporal sequence relationship in the concatenated text feature also have relevance. For example, by concatenating matched image-text pairs comprising <Image 1, Text 1>, <Image 2, Text 2>, <Image 3, Text 3>, and <Image 4, Text 4>, a concatenated image sample <Image 1-Image 2-Image 3-Image 4> and a concatenated text sample <Text 1-Text 2-Text 3-Text 4> are obtained. It can be seen that, the concatenated image sample and the concatenated text sample have a correspondence and are correlated in a concatenation order. Therefore, after feature extraction is performed on the concatenated image sample <Image 1-Image 2-Image 3-Image 4>, concatenated image feature with time information are obtained. After feature extraction is performed on the concatenated text sample <Text 1-Text 2-Text 3-Text 4>, a concatenated text feature with a temporal sequence relationship are obtained. The time information in the concatenated image feature and the temporal sequence relationship in the concatenated text feature are correspondingly correlated.

In some embodiments, obtaining training samples may further comprise:
obtaining a plurality of training image-text pairs of at least one batch; and
obtaining the concatenated image sample and the corresponding concatenated text sample by concatenating, for each training image-text pair of each batch, a preset number of training image-text pairs in a same batch.

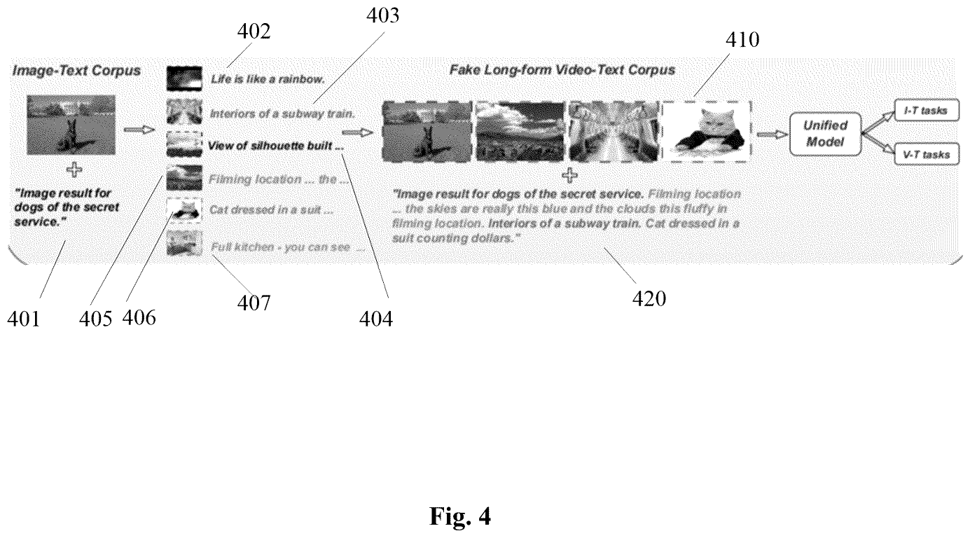

The training image-text pair may comprise an image sample and a corresponding text sample. For example, a training image-text pair <I, T> comprises an image sample I and a corresponding text sample T, where the text sample T may be used for describing a scene of the image sample I. An image that is pre-labeled or matched with a corresponding text may be used as an image-text pair. In the pre-training process, the initial model may be trained in batches, with each batch comprising a plurality of training image-text pairs. For each training image-text pair <I, T>ᵢ in each batch, i is a positive integer, a certain number of other training image-text pairs <I, T>ⱼ may be randomly selected and concatenated with each training image-text pair <I, T>ᵢ, where j≠i and j is a positive integer. Specifically, an image-text database may be converted into a concatenated image-concatenated text database in a manner of online sample concatenation. For each image-text sample in each batch, a certain number of other image-text samples can be randomly selected from the same batch for concatenation. Referring to FIG. 4, FIG. 4 illustrates a schematic diagram of a training sample according to an embodiment of the disclosure. In FIG. 4, for a training image-text pair 401, a preset number (e.g., 3) of training image-text pairs 403, 405, and 406 may be selected from training image-text pairs 402 to 407 in the same batch for concatenation. A concatenation order may be sequential concatenation of the training image-text pairs 401, 405, 403, and 406, that is, image samples of the training image-text pairs 401, 405, 403, and 406 are sequentially concatenated into a concatenated image sample 410, text samples are spliced into a text paragraph, i.e., a concatenated text sample 420, and the concatenated image sample 410 and concatenated text sample 420 form a concatenated training sample. It can be seen that through the concatenation of images and texts, a clear correspondence between events represented by the images and sentences in the texts is ensured.

In some embodiments, the concatenated text sample comprises a plurality of text samples concatenated; and
obtaining the concatenated image feature with time information by performing feature extraction based on the concatenated image sample:
obtaining image features by performing feature extraction on image samples in the concatenated image sample sequentially according to a concatenation order; and
obtaining the concatenated image feature by embedding corresponding time information into the image features based on the concatenation order and concatenating the image features embedded with time information.

In some embodiments, the concatenated text sample comprises a plurality of text samples concatenated, and the text samples correspond to the image samples; and
obtaining the concatenated text feature with the temporal sequence relationship by performing feature extraction based on the text samples comprises:
concatenating the corresponding text samples into a text segment based on the concatenation order of the image samples; and
obtaining the concatenated text feature with the temporal sequence relationship by performing feature extraction on the text segment and embedding position information of the text samples in the text segment.

Specifically, for an image sample part, the image samples in the concatenated image sample are sequentially inputted into the visual encoder, and the time information of the image samples are embedded into an output feature of the concatenated image sample and are concatenated along a temporal sequence dimension to obtain the concatenated image feature. For a text sample part, the corresponding text samples can be directly concatenated into a long paragraph based on the concatenation order of the image samples, while the temporal sequence relationship of the text samples may be encoded through a positional embedding layer of the text encoder. The images are regarded as snapshots of a plurality of segments, and these segments constitute a pseudo-long form video, with each segment capturing different scenes and corresponding textual descriptions. Through sample concatenation and positional embedding, the model may be trained to learn explicit scene-level temporal alignment.

In the prior art, due to the high cost of video uploading, storage, and downloading, there is a limited amount of available open source video-text data, which restricts the performance of a video-based visual-language model in temporal semantic representation and relevance modeling. The pre-training of the model is constrained by the size and the quality of the video-text training corpus. Compared with the prior art, according to the concatenated training sample in the embodiments of the disclosure, the image and text samples are converted into the concatenated image-concatenated text samples in a manner of online sample splicing and concatenation, and meanwhile visual content and event-level time clues are modeled. The concatenated images and texts maintain a temporal sequence correspondence, providing rich scene transition and descriptive information, while reducing visual redundancy through sampling randomness. Meanwhile, through sample splicing and positional embedding encoding, the model can learn explicit scene-level time alignment, thereby the capability of the model in learning both static and temporal information is improved.

A related large-scale visual-language model is typically trained only an image-text corpora, neglecting joint modeling between images and videos. In the process of pre-training the cross-modal data processing model in the embodiments of the disclosure, by performing sample concatenation on the images and the texts, association of the static and time information can be captured in the pre-training stage, thereby the video-text reasoning capability is improved. Meanwhile, the scope of video semantic modeling is effectively expanded by performing joint modeling on the images and the texts.

In some embodiments, obtaining the multi-modal feature by performing fusing based on the concatenated image feature and the concatenated text feature comprises:
obtaining a text self-attention feature by performing self-attention calculation based on the concatenated text feature; and
obtaining the multi-modal feature by performing cross-attention calculation based on the text self-attention feature and the concatenated image feature.

To enhance cross-modal alignment, comprehension, and generation capabilities of the model, at least one of the following training objectives may be adopted: image-text contrast (ITC), image-text matching (ITM), masked language modeling (MLM), and generative modeling (GM).

In some embodiments, pre-training the initial model based on the concatenated image sample, the concatenated text sample, and the multi-modal feature comprises:
determining the concatenated image feature of the concatenated image sample and the corresponding concatenated text feature in the concatenated text sample as a positive sample pair, and determining the concatenated image feature and a non-corresponding concatenated text feature as a negative sample pair;
calculating a first similarity of the positive sample pair and a second similarity of the negative sample pair; and
adjusting a first model parameter of the initial model to minimize the first similarity and maximize the second similarity.

For a training objective of concatenated image-concatenated text contrast (CITC), a global representation of the concatenated image may be obtained through the visual encoder, a representation of the concatenated text is obtained based on a category feature (e.g., a [CLS] feature) of the text encoder, and a bidirectional contrastive loss is used for clustering paired concatenated samples together and pushing apart unpaired samples. For example, m (m is a positive integer) frames of images are respectively inputted into the visual encoder, and an average of outputted category features (e.g., [CLS] features) serves as a global feature of the concatenated image sample, namely the concatenated image feature; m text samples corresponding to the m frames of images are spliced to obtain a concatenated text sample; and the concatenated text sample is inputted into the text encoder, and an outputted category feature (e.g., a [CLS] feature) serves as a text global feature of the concatenated text sample, namely the concatenated text feature. Evidently, the concatenated image feature matches the corresponding concatenated text feature. Contrastive learning may be used for shortening the distance between the concatenated image feature and concatenated text feature that are matched and lengthening the distance between the concatenated image feature and the concatenated text feature that are not matched in metric space.

In some embodiments, pre-training the initial model based on the concatenated image sample, the concatenated text sample, and the multi-modal feature comprises:
calculating a matching confidence for the concatenated image sample and the concatenated text sample;
obtaining a first loss function by calculating a sum of binary classification losses for all matching confidences based on category labels; and
adjusting a second model parameter of the initial model based on the first loss function to minimize the first loss function.

For a training objective of concatenated image-concatenated text matching (CITM), the model may be trained to determine whether a long video corresponds to a paragraph. A method of hard negative sample mining may be adopted to calculate a binary classification loss function using a multilayer perceptron (MLP) through the category feature (e.g., the [CLS] feature) of the text encoder. Specifically, one of a concatenated image sample A_image and a concatenated text sample A_text which are mutually in correspondence is replaced with another mismatched sample from the same batch. For example, the concatenated image sample A_image is replaced with another concatenated image sample B_image from the same batch, and then, whether the concatenated image sample B_image matches the concatenated text sample A_text is determined based on the category feature of the text encoder, thereby a binary classification loss function is obtained.

In some embodiments, pre-training the initial model based on the concatenated image sample, the concatenated text sample, and the multi-modal feature comprises:
generating a first concatenated text mask sample based on the concatenated text sample;
obtaining a first concatenated text mask feature by performing self-attention calculation based on the first concatenated text mask sample;
obtain a first image-text mask feature by performing cross-attention calculation based on the concatenated image feature and the first concatenated text mask feature;
calculating a second loss function between the first image-text mask cross-attention features and the multi-modal feature; and
adjusting a third model parameter of the initial model based on the second loss function to minimize the second loss function.

For a training objective of concatenated masked language modeling (CMLM), a certain proportion (e.g., 15%) of labels in the concatenated text may be randomly masked, and a prediction layer of the text encoder is used for reconstructing the masked labels in the context of the concatenated image sample. Then, a second loss function is calculated between the reconstructed labels and a real sample (e.g., a multi-modal feature). A text mask sample may be obtained based on a text sample and a preset text masking strategy. Further, obtaining a text mask sample based on a text sample and a preset text masking strategy comprises: a preset proportion of words in the text sample are randomly selected for masking to generate the text mask sample. It should be understood that the number of words in a preset proportion may not be an integer, which may be rounded (e.g., rounding) as needed for masking. This is not limited here.

In some embodiments, pre-training the initial model based on the concatenated image feature, the concatenated text feature, and the multi-modal feature comprises:
generating a second concatenated text mask sample based on the concatenated text sample;
obtaining a second concatenated text mask feature by performing causal self-attention calculation based on the second concatenated text mask sample;
obtaining a second image-text mask feature by performing cross-attention calculation based on the concatenated image feature and the second concatenated text mask feature;
calculating a third loss function between the second image-text mask cross-attention feature and the multi-modal feature; and
adjusting a fourth model parameter of the initial model based on the third loss function to minimize the third loss function.

For a training objective of concatenated generation modeling (CGM), a certain proportion (e.g., 60%) of labels in the paragraph may be randomly masked, and the same prediction layer as CMLM is used for reconstructing the masked labels in the context of the concatenated image sample. CGM introduces causal attention masks in the self-attention layer of the text encoder to prevent information leakage and enhance a text generation capability of the model.

In some embodiments, pre-training the initial model based on the concatenated image feature, the concatenated text feature, and the multi-modal feature comprises:
determining the image sample and a corresponding text sample as a single positive sample pair, and determining the image sample and a non-corresponding text sample in a training sample as a single negative sample pair;
calculating a third similarity of the single positive sample pair and a fourth similarity of the single negative sample pair; and
adjusting a fifth model parameter of the initial model to minimize the third similarity and maximize the fourth similarity.

Image-text contrastive learning (ITC) may also be adopted as a training objective. Specifically, an image sample and a corresponding text sample may be regarded as a single positive sample pair, and all other samples in the same batch are considered as single negative sample pairs. A loss function is then calculated by comparing cosine similarity distances between the sample pairs. Comparing the distances between single positive sample pairs and single negative sample pairs may bring the distance between the positive sample pairs smaller and the distance between the negative sample pairs larger.

In some embodiments, pre-training the initial model based on the concatenated image feature, the concatenated text feature, and the multi-modal feature comprises:
calculating an image-sample matching confidence for the image sample and the text sample;
calculating the sum of binary classification losses for all image-sample matching confidences based on category labels to obtain a fourth loss function; and
adjusting a fifth model parameter of the initial model based on the fourth loss function to minimize the fourth loss function.

Specifically, image-text matching (ITM) may also be used as a training objective, and is the same as the training objective of image-text contrast, which can enhance the capability of the model in processing single samples.

The pre-trained model obtained after the pre-training stage may utilize rich information of the images and the texts to better capture the correlation between vision and language, as well as an accurate event-description correspondence, thereby greatly enhancing the performance the model. Based on this, the pre-trained model may also be trained specially for different downstream tasks to obtain a multi-modal data processing model used for different downstream tasks (e.g., long/short video-text tasks and image-text tasks, comprising retrieval, caption generation, and question answering).

In some embodiments, the method may further comprise: obtaining the cross-modal data processing model by training the pre-trained model based on a task training sample.

Further, in some embodiments, obtain the cross-modal data processing model by training the pre-trained model based on a task training sample comprises:
obtaining the task training sample, wherein the task training sample comprises at least one video-text task training pair (or an image-text task training pair, comprising an image task training sample and a corresponding text task training sample), and each video-text task training pair comprises a video task training sample and a corresponding text task training sample; and
obtaining the cross-modal data processing model by training the pre-trained model based on the task training sample until meeting a target training requirement.

For different cross-modal data processing tasks, the content comprised in the task training sample may vary. For example, for a visual information generation task, the cross-modal data processing model may generate, based on visual data (e.g., video data or image data), text information (e.g., a summary, a title, and a brief introduction) associated with the visual data. In this case, a task training sample corresponding to a video information generation task may comprise at least one video-text information pair. Each video-text information pair comprises a video training sample and corresponding text information such as a summary, a title, and a brief introduction.

For a text-visual generation task, the cross-modal data processing model may generate, based on text data, visual data (e.g., an image and a video) corresponding to the text data. In this case, a task training sample corresponding to the text-visual generation task may comprise at least one text-visual information pair. Each text-visual information pair comprises text information such as a summary, a title, and a brief introduction, as well as corresponding visual data.

It can be seen that the pre-trained model obtained through the cross-modal data processing method according to the embodiments of the disclosure can ensure high efficiency and high performance in task processing between different modal data.

Referring to FIG. 5, FIG. 5 illustrates a schematic flowchart of a cross-modal data processing method according to an embodiment of the disclosure. As shown in FIG. 5, the cross-modal data processing method 500 may be implemented based on the cross-modal data processing model shown in FIG. 3, and further comprises the following steps.

Step S510: obtaining first modal data to be processed.

The first modal data may refer to visual data, comprising image data or video data. The first modal data may also refer to text data.

Step S520: obtaining a first modal data feature by performing feature extraction based on the first modal data.

Specifically, feature extraction may be performed on the first modal data based on an image encoder 310 or a text encoder 320 to obtain the first modal data feature.

Step S530: obtaining second modal data based on the first modal data feature and a cross-modal processing model, the first modal data and the second modal data having different modalities, wherein the cross-modal processing model needs to be pre-trained based on a concatenated training sample, and the concatenated training sample comprises a concatenated image sample and a corresponding concatenated text sample.

The second modal data differs from the modality of the first modal data. For example, when the first modal data is visual data, the second modal data may be text data. When the first modal data is text data, the second modal data may be visual data.

Specifically, for video data to be processed, a user may want to generate corresponding summary information for the video data. The cross-modal data processing model may perform feature extraction on the video data to obtain a first modal data feature, namely a video feature. The first modal data feature may be a feature vector. The cross-modal data processing model performs, based on the first modal data feature, searching and matching in a text feature set, and the text feature set may be a set of text features obtained after performing feature extraction on a preset text. One or more target text features that match temporal sequence image features can be obtained after searching and matching. Based on a target preset text corresponding to the one or more target text features, a target text about the video data may be formed as summary information. According to the cross-modal data processing method in the embodiments of the disclosure, the cross-modal data processing model is adopted to generate relevant text information based on the video, thereby improving accuracy of the text information.

For text data to be processed, the user wants to generate corresponding video data for the text data. The cross-modal data processing model may perform feature extraction on the text data to obtain a first modal data feature, namely a text feature. The first modal data feature may be a feature vector. The cross-modal data processing model performs, based on the first modal data feature, searching and matching in a video feature set, and the video feature set may be a set of video features obtained after performing feature extraction on a preset video. One or more target video features that match the text feature can be obtained after searching and matching. Based on a target preset video corresponding to the one or more target video features, target video data about the text data may be formed. According to the cross-modal data processing method in the embodiments of the disclosure, the cross-modal data processing model is adopted to generate relevant video information based on the text, thereby improving video data generation accuracy.

It should be noted that the method in the embodiments of the disclosure may be performed by a single device, such as a computer or a server. The method in the embodiments may also be applied to a distributed scenario to be completed through cooperation of a plurality of devices. In the distributed scenario, one of the plurality of devices may only perform one or more steps of the method in the embodiments of the disclosure. The plurality of devices interact with each another to complete the method.

It should be noted that some embodiments of the disclosure are described above. Other embodiments are within the scope of the appended claims. In some cases, the actions or steps recorded in the claims may be performed in an order different from that in the foregoing embodiments, and can still achieve desired results. In addition, the processes depicted in the accompanying drawings do necessarily require a specific or consecutive order shown to achieve the desired results. In some implementations, multi-task processing and parallel processing are also possible or may be advantageous.

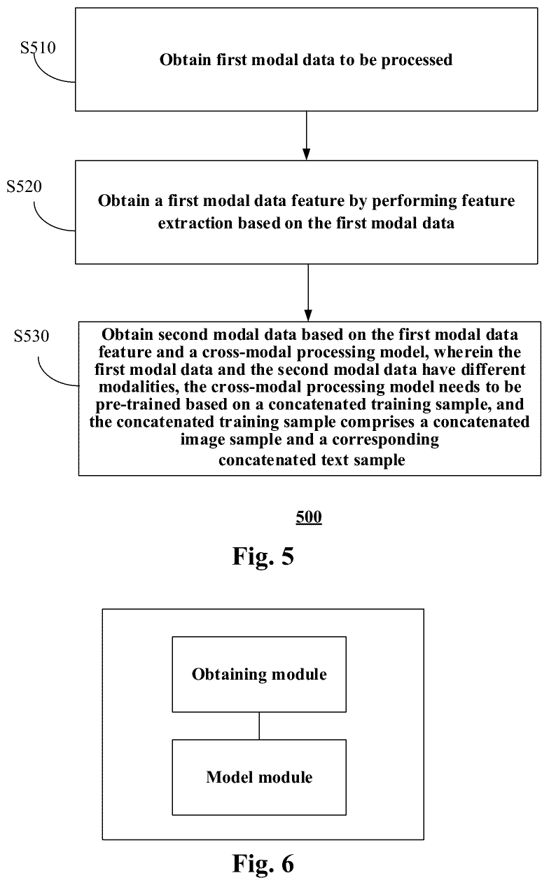

Based on the same technical concept, corresponding to the method in any one of the foregoing embodiments, the disclosure further provides a cross-modal data processing apparatus. Referring to FIG. 6, the cross-modal data processing apparatus comprises:
an obtaining module, configured to obtain first modal data to be processed; and
a model module, configured to obtain a first modal data feature by performing feature extraction based on the first modal data, and obtain second modal data based on the first modal data feature and a cross-modal processing model, the first modal data and the second modal data having different modalities,
wherein the cross-modal processing model needs to be pre-trained based on a concatenated training sample, and the concatenated training sample comprises a concatenated image sample and a corresponding concatenated text sample.

For ease of description, the above apparatus is respectively described with various modules divided according to functions. Of course, during implementing the disclosure, the functions of the modules may be implemented in the same one or more software and/or hardware.

The apparatus of the above embodiment is configured to implement the corresponding cross-modal data processing method in any one of the foregoing embodiments, and has the beneficial effects of the corresponding method embodiment. Details are not repeated here.

Based on the same technical concept, corresponding to the method in any one of the foregoing embodiments, the disclosure further provides a non-transitory computer-readable storage medium, storing computer instructions. The computer instructions are configured to enable the computer to perform the cross-modal data processing method in any one of the foregoing embodiments.

The computer-readable medium in this embodiment comprises permanent and non-permanent, removable and non-removable media, which may implement information storage by any method or technology. Information may be computer-readable instructions, a data structure, a program module, or other data. Examples of the computer storage medium comprise, but are not limited to, a phase-change memory (PRAM), a static random access memory (SRAM), a dynamic random access memory (DRAM), another type of random access memory (RAM), a read only memory (ROM), an electrically erasable programmable read only memory (EEPROM), a flash memory or other memory technologies, a compact disc read only memory (CD-ROM), a digital versatile disc (DVD) or other optical storage, a magnetic cassette tape, a magnetic disk storage, or other magnetic storage devices, or any other non-transmission medium that can be configured to store information accessible to a computing device.

The computer instructions stored in the storage medium of the above embodiment are configured to enable the computer to perform the cross-modal data processing method in any one of the foregoing embodiments, and has the beneficial effects of the corresponding method embodiment. Details are not repeated here.

Those of ordinary skill in the art should understand that the discussion about any above embodiment is exemplary and is not intended to imply that the scope (comprising the claims) of the disclosure is limited to these examples; and under the idea of the disclosure, technical features in the foregoing embodiments or in different embodiments may also be combined, the steps may be implemented in any order, and many other variations of different aspects in the foregoing embodiments of the disclosure may exist, and for brevity, are not provided in detail.

In addition, to simplify the description and discussion, and to avoid making the embodiments of the disclosure difficult to understand, known power/ground connections to an integrated circuit (IC) chip and other components may or may not be shown in the provided accompanying drawings. Further, the apparatuses may be shown in the form of block diagrams to avoid making the embodiments of the disclosure difficult to understand. The following fact is also considered, that is, the details of the implementation of the apparatuses in these block diagrams are highly dependent on a platform on which the embodiments of the disclosure will be implemented (i.e., these details should be completely within the understanding scope of those skilled in the art). When the specific details (e.g., a circuit) are elaborated to describe the exemplary embodiments of the disclosure, it is apparent to those skilled in the art that the embodiments of the disclosure can be implemented without these specific details or with variations of these specific details. Therefore, these descriptions should be considered illustrative rather than restrictive.

Although the disclosure has been described in conjunction with the specific embodiments of the disclosure, many substitutions, modifications, and variations of these embodiments are apparent to those of ordinary skill in the art according to the foregoing descriptions. For example, other memory architectures (e.g., a dynamic RAM (DRAM)) may use the discussed embodiments.

The embodiments of the disclosure are intended to cover all such substitutions, modifications, and variations that fall within the broad scope of the appended claims. Therefore, any omissions, modifications, equivalent substitutions, improvements, etc., made within the spirit and principle of the embodiments of the disclosure shall fall within the scope of protection of the disclosure.

I/We claim:

1. A cross-modal data processing method, comprising:
obtaining first modal data to be processed;
obtaining a first modal data feature by performing feature extraction based on the first modal data; and
obtaining second modal data based on the first modal data feature and a cross-modal processing model, the first modal data and the second modal data having different modalities,
wherein the cross-modal processing model needs to be pre-trained based on a concatenated training sample, and the concatenated training sample comprises a concatenated image sample and a corresponding concatenated text sample.

2. The method according to claim 1, wherein the operation that the cross-modal processing model needs to be pre-trained based on the concatenated training sample comprises:
obtaining the concatenated training sample, wherein the training sample comprises the concatenated image sample and the corresponding concatenated text sample;
obtaining a concatenated image feature with time information by performing feature extraction based on the concatenated image sample, and obtaining a concatenated text feature with a temporal sequence relationship by performing feature extraction based on the text sample;
obtaining a multi-modal feature by performing fusing based on the concatenated image feature and the concatenated text feature; and
pre-training the initial model based on the concatenated image sample, the concatenated text sample, and the multi-modal feature.

3. The method according to claim 2, wherein obtaining the concatenated training sample comprises:
obtaining a plurality of training image-text pairs of at least one batch; and
obtaining the concatenated image sample and the corresponding concatenated text sample by concatenating, for each training image-text pair of each batch, a preset number of training image-text pairs in a same batch.

4. The method according to claim 3, wherein the concatenated image sample comprises a plurality of image samples concatenated, and
obtaining the concatenated image feature with time information by performing feature extraction based on the concatenated image sample comprises:
obtaining image features by performing feature extraction on image samples in the concatenated image sample sequentially according to a concatenation order; and
obtaining the concatenated image feature by embedding corresponding time information into the image features based on the concatenation order and concatenating the image features embedded with time information.

5. The method according to claim 3, wherein the concatenated text sample comprises a plurality of text samples concatenated, and the text samples correspond to the image samples, and
obtaining the concatenated text feature with the temporal sequence relationship by performing feature extraction based on the text samples comprises:
concatenating the corresponding text samples into a text segment based on the concatenation order of the image samples; and
obtaining the concatenated text feature with the temporal sequence relationship by performing feature extraction on the text segment and embedding position information of the text samples in the text segment.

6. The method according to claim 2, wherein obtaining the multi-modal feature by performing fusing based on the concatenated image feature and the concatenated text feature comprises:
obtaining a text self-attention feature by performing self-attention calculation based on the concatenated text feature; and
obtaining the multi-modal feature by performing cross-attention calculation based on the text self-attention feature and the concatenated image feature.

7. The method according to claim 2, wherein pre-training the initial model based on the concatenated image sample, the concatenated text sample, and the multi-modal feature comprises:
determining the concatenated image feature of the concatenated image sample and the corresponding concatenated text feature in the concatenated text sample as a positive sample pair, and determining the concatenated image feature and a non-corresponding concatenated text feature as a negative sample pair;
calculating a first similarity of the positive sample pair and a second similarity of the negative sample pair; and
adjusting a first model parameter of the initial model to minimize the first similarity and maximize the second similarity.

8. The method according to claim 2, wherein pre-training the initial model based on the concatenated image sample, the concatenated text sample, and the multi-modal feature comprises:
calculating a matching confidence for the concatenated image sample and the concatenated text sample;
obtaining a first loss function by calculating a sum of binary classification losses for all matching confidences based on category labels; and
adjusting a second model parameter of the initial model based on the first loss function to minimize the first loss function.

9. The method according to claim 2, wherein pre-training the initial model based on the concatenated image sample, the concatenated text sample, and the multi-modal feature comprises:
generating a first concatenated text mask sample based on the concatenated text sample;
obtaining a first concatenated text mask feature by performing self-attention calculation based on the first concatenated text mask sample;
obtaining a first image-text mask feature by performing cross-attention calculation based on the concatenated image feature and the first concatenated text mask feature;
calculating a second loss function between the first image-text mask cross-attention features and the multi-modal feature; and
adjusting a third model parameter of the initial model based on the second loss function to minimize the second loss function.

10. The method according to claim 2, wherein pre-training the initial model based on the concatenated image feature, the concatenated text feature, and the multi-modal feature comprises:
generating a second concatenated text mask sample based on the concatenated text sample;
obtaining a second concatenated text mask feature by performing causal self-attention calculation based on the second concatenated text mask sample;
obtaining a second image-text mask feature by performing cross-attention calculation based on the concatenated image feature and the second concatenated text mask feature;
calculating a third loss function between the second image-text mask cross-attention feature and the multi-modal feature; and
adjusting a fourth model parameter of the initial model based on the third loss function to minimize the third loss function.

11. An electronic device, comprising a memory, a processor, and a computer program stored on the memory being executable on the processor, wherein the program, when executed by the processor, causes the processor to:
obtain first modal data to be processed;
obtain a first modal data feature by performing feature extraction based on the first modal data; and
obtain second modal data based on the first modal data feature and a cross-modal processing model, the first modal data and the second modal data having different modalities,
wherein the cross-modal processing model needs to be pre-trained based on a concatenated training sample, and the concatenated training sample comprises a concatenated image sample and a corresponding concatenated text sample.

12. The device according to claim 11, wherein the program further causes the processor to:
obtain the concatenated training sample, wherein the training sample comprises the concatenated image sample and the corresponding concatenated text sample;
obtain a concatenated image feature with time information by performing feature extraction based on the concatenated image sample, and obtain a concatenated text feature with a temporal sequence relationship by performing feature extraction based on the text sample;
obtain a multi-modal feature by performing fusing based on the concatenated image feature and the concatenated text feature; and
pre-train the initial model based on the concatenated image sample, the concatenated text sample, and the multi-modal feature.

13. The device according to claim 12, wherein the program causing the processor to obtain the concatenated training sample further causes the processor to:
obtain a plurality of training image-text pairs of at least one batch; and
obtain the concatenated image sample and the corresponding concatenated text sample by concatenating, for each training image-text pair of each batch, a preset number of training image-text pairs in a same batch.

14. The device according to claim 13, wherein the concatenated image sample comprises a plurality of image samples concatenated, and
the program causing the processor to obtain the concatenated image feature with time information by performing feature extraction based on the concatenated image sample further causes the processor to:
obtain image features by performing feature extraction on image samples in the concatenated image sample sequentially according to a concatenation order; and
obtain the concatenated image feature by embedding corresponding time information into the image features based on the concatenation order and concatenating the image features embedded with time information.

15. The device according to claim 13, wherein the concatenated text sample comprises a plurality of text samples concatenated, and the text samples correspond to the image samples, and
The program causing the processor to obtain the concatenated text feature with the temporal sequence relationship by performing feature extraction based on the text samples further causes the processor to:
concatenate the corresponding text samples into a text segment based on the concatenation order of the image samples; and
obtain the concatenated text feature with the temporal sequence relationship by performing feature extraction on the text segment and embedding position information of the text samples in the text segment.

16. The device according to claim 12, wherein the program causing the processor to obtain the multi-modal feature by performing fusing based on the concatenated image feature and the concatenated text feature further causes the processor to:
obtain a text self-attention feature by performing self-attention calculation based on the concatenated text feature; and
obtain the multi-modal feature by performing cross-attention calculation based on the text self-attention feature and the concatenated image feature.

17. The device according to claim 12, wherein the program causing the processor to pre-train the initial model based on the concatenated image sample, the concatenated text sample, and the multi-modal feature further causes the processor to:
determine the concatenated image feature of the concatenated image sample and the corresponding concatenated text feature in the concatenated text sample as a positive sample pair, and determine the concatenated image feature and a non-corresponding concatenated text feature as a negative sample pair;
calculate a first similarity of the positive sample pair and a second similarity of the negative sample pair; and
adjust a first model parameter of the initial model to minimize the first similarity and maximize the second similarity.

18. The device according to claim 12, wherein the program causing the processor to pre-train the initial model based on the concatenated image sample, the concatenated text sample, and the multi-modal feature further causes the processor to:
calculate a matching confidence for the concatenated image sample and the concatenated text sample;
obtain a first loss function by calculating a sum of binary classification losses for all matching confidences based on category labels; and
adjust a second model parameter of the initial model based on the first loss function to minimize the first loss function.

19. The device according to claim 12, wherein the program causing the processor to pre-train the initial model based on the concatenated image sample, the concatenated text sample, and the multi-modal feature further causes the processor to:
generate a first concatenated text mask sample based on the concatenated text sample;
obtain a first concatenated text mask feature by performing self-attention calculation based on the first concatenated text mask sample;
obtain a first image-text mask feature by performing cross-attention calculation based on the concatenated image feature and the first concatenated text mask feature;
calculate a second loss function between the first image-text mask cross-attention features and the multi-modal feature; and
adjust a third model parameter of the initial model based on the second loss function to minimize the second loss function.

20. A non-transitory computer-readable storage medium, wherein the non-transitory computer-readable storage medium stores computer instructions, and the computer instructions are configured to cause a computer to:
obtain first modal data to be processed;
obtain a first modal data feature by performing feature extraction based on the first modal data; and
obtain second modal data based on the first modal data feature and a cross-modal processing model, the first modal data and the second modal data having different modalities,
wherein the cross-modal processing model needs to be pre-trained based on a concatenated training sample, and the concatenated training sample comprises a concatenated image sample and a corresponding concatenated text sample.
